(19) United States
(12) Patent Application Publication
(10) Pub. No.: US 2007/0020603 A1
(43) Pub. Date: Jan. 25, 2007

(54) Synchronous communications systems and methods for distance education

(76) Inventor: Rebecca Woulfe, Lakewood, CO (US)

Correspondence Address: TRENNER LAW FIRM, LLC, 12081 WEST ALAMEDA PARKWAY #163, LAKEWOOD, CO, 80228, US

(21) Appl. No.: 11/409,465

(22) Filed: Apr. 21, 2006

Related U.S. Application Data
(60) Provisional application No. 60/701,771, filed on Jul. 22, 2005.

(51) Int. Cl. G09B 3/00

(52) U.S. Cl. 434/350

(57) ABSTRACT

Systems and methods of synchronous communication for distance education are disclosed. In an exemplary embodiment, a method may comprise receiving user input from a plurality of users for a current virtual classroom session regardless of input format, and receiving facilitator input from at least one facilitator for the current virtual classroom session. The method may also comprise selecting a delivery template from among a plurality of delivery templates, the plurality of delivery templates corresponding to different types of virtual classroom sessions, and the selected delivery template corresponding to the type of the current virtual classroom session. The method may also comprise merging the user input and facilitator input into a composite output based on the selected delivery template, and issuing the composite output to each of the plurality of users for the current virtual classroom session.

### PRIORITY CLAIM

This application claims priority to co-owned U.S. Provisional Patent Application No. 60/701,771 for “Personal Video Communications Systems and Methods” of Rebecca Woulfe, filed Jul. 22, 2005, hereby incorporated by reference in its entirety as though fully set forth herein.

### TECHNICAL FIELD

The described subject matter relates to electronic communication in general and more particularly to synchronous communication systems and methods for distance education.

### BACKGROUND

Distance education is a fast-growing market for distributing education across the country and around the globe. The market for distance education is expanding at a remarkable pace with annual increases ranging from 25% - 50% per year. Current models for distance education use what is called a Learning Management System (LMS) to provide written content, asynchronous interaction (not in “real-time”) via postings on an online discussion board, and testing and other assessment strategies. The current LMS model typically requires a personal computer (PC) and the Internet.

Although the price of a PC continues to drop, there is still a large percentage of the world population that does not have PCs. Of those individuals who do own PCs, many are intimidated by the technology and use it, e.g., only for basic word processing and email.

Even among those who have PCs, many students do not have reliable access to the Internet. The cost of a high-speed connection may be prohibitive for some, and many students are frustrated working on dial-up connections. Many Internet connections are also unreliable and may experience time-out issues and internet service provider (ISP) downtime. There are also still many remote areas of the globe that simply do not have Internet access.

Internet security also inhibits effective delivery of distance education. The Internet, and databases containing personal information, have been targets of criminal activity. Identify theft, viruses, and spamming are just a few examples. These offenses have forced educational institutions and businesses to strengthen their security measures. These security measures, however, may restrict the user's ability to download necessary plug-ins, prevent students from accessing critical Internet sites, and may still not prevent all viruses which can take down entire college and university networks for days, if not weeks at a time.

Finally, research has found that the single most important barrier to students learning online is a lack of social interaction. Although some LMS's provide the ability for chatroom-based collaboration, many people find this tool frustrating because of slow Internet speeds and the need to download plug-ins.

### BRIEF DESCRIPTION OF THE DRAWINGS

FIG. 1 is a high-level schematic illustration of an exemplary synchronous communication system for distance education.

FIG. 2 is a screen shot showing an exemplary user interface which may be implemented by a facilitator for synchronous communication for distance education.

FIGS. 3a-f are screen shots showing exemplary delivery templates which may be implemented for synchronous communication for distance education.

FIG. 4 is a high-level diagram illustrating exemplary functional modules which may be implemented for synchronous communication for distance education.

FIG. 5 is a flowchart illustrating exemplary operations which may be implemented for synchronous communication for distance education.

### DETAILED DESCRIPTION

Synchronous communication systems and methods for distance education are disclosed herein. Exemplary systems enable two-way communication, both visual and audio, between one or more facilitator (e.g., professors, teachers, teacher's aids, moderators, etc.) and other users (e.g., students, participants, etc.) in a virtual classroom setting. The facilitator and users may be at remote locations, e.g., so that students can attend class from the comfort of their own homes.

In exemplary embodiments, audio and video (AV) data is submitted by the users via a mobile phone, video phone, personal digital assistant (PDA), or other device having audio and video capture capability. The user data is compiled into a real-time video file that also includes facilitator data (e.g., audio, video, and optionally supplemental material such as text, images, and animations) using delivery templates.

Delivery templates enable the facilitator to recreate the interactive component of a traditional classroom. For example, facilitators can incorporate the use of debate, case studies, presentations, group work, competitions, and collaborative learning activities into a distance education course by selecting the corresponding delivery template.

The user data and facilitator data may then be broadcast to the users via a service provider (e.g., cable television or satellite communication system) and output, e.g., on the users' home televisions (TV). In such embodiments, the users do not need to have a PC or access to the Internet. Students may interact with the facilitator and other users continually throughout the session.

Although exemplary embodiments are described herein with reference to distance education, it will be readily appreciated by those having ordinary skill in the art after having become familiar with the teachings herein that the systems and methods may also be implemented in a wide variety of other fields, including for example, but not limited to use in the healthcare industry for patient/specialist interaction, in business for corporate-wide training, in consumer markets for individuals to communicate with friends and families, and even in politics, to name only a few examples.

Exemplary Systems

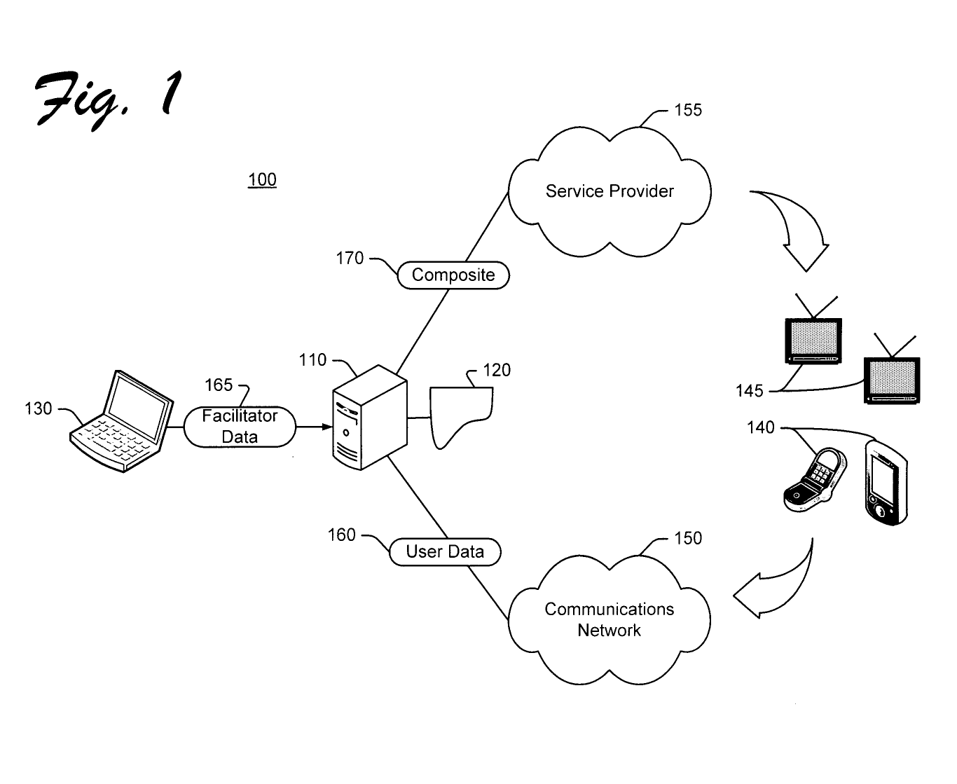

FIG. 1 is a high-level schematic illustration of an exemplary synchronous (or “real-time”) communication system 100 for distance education. System 100 may include one or more computing devices or server computer 110 for executing program code 120 (e.g., application software). A facilitator computing device or facilitator computer 130 may be communicatively coupled to the server computer 110, e.g., via direct connection or computer network. One or more user devices 140, 145 may also be communicatively coupled to the server computer 110, e.g., via communications network 150 and service provider network 155.

The server computer 110 and facilitator computer 130 may be any suitable computing device, having at least processing capability sufficient to establish the described communication channels, and operatively associated with computer-readable storage. For example, server computer 1 10 may be any commercially available network computer server, and the facilitator computer 130 may be a personal computer (PC), laptop computer, workstation, or the like. Such computing devices are well known and therefore further description is not required.

In an exemplary embodiment, communications network 150 may include a mobile phone network which users may access via mobile phones or other mobile devices 140. It is noted, however, that other communications networks may also be implemented. For example, the communications network 150 may be a conventional connection-oriented telephone network, an IP-based network, or a combination of these and/or other communications networks now known or later developed.

Also in an exemplary embodiment, service provider network 155 may include a satellite network which users may receive an audio/visual feed via televisions or other output devices 145. The service provider may selectively control the users that are able to receive a signal from the system 100 by registration, similarly to how the satellite and cable television service providers currently enable selective distribution of television signals. Although satellite networks currently provide the greatest flexibility and ability to reach remote areas, other service provider networks may also be implemented. For example, the service provider network 155 may be a cable television, wireless Internet network, local broadcast, satellite radio, or a combination of these and/or other service provider networks now known or later developed.

The server computer 110 handles incoming data from communications network 150, information from LANs or WANS on which the facilitator computer 130 may be connected, and outgoing processes such as linking to service providers. The server computer 110 may also record and store session information (or even complete copies of sessions) for future review or asynchronous broadcast.

During operation, each user may be remotely located (e.g., at his or her own home), and users may establish a communications connection to the server computer 110, e.g., by dialing a predetermined number on their mobile devices 140. In an exemplary embodiment, the mobile devices 140 incorporate 3G (third generation) or higher technology for establishing the communications connection with the server computer 110. Video capability on the mobile devices 140 may be used to capture the users' facial images, and the standard voice features may be used to capture the users' conversations. Both the audio and video (collectively illustrated in FIG. 1 as user data 160) are delivered to the server computer 110 via the communications network 150. User data 160 may be received in any of a wide variety of file formats including, but not limited to the following computer-readable file formats: .doc, .txt, .rtf, .ppt, xls., MPEG4, .gif, .tif, .jpeg, .wmp, .swf, .htm, and .pdf. In an exemplary embodiment, the user data 160 may be received regardless of any particular type of file format implemented by the user. Accordingly, users are not restricted to any particular type of equipment and/or software.

Video and audio capture capability is also provided for the facilitator (e.g., a webcam and microphone at the facilitator's computer 130) so that the facilitator can capture his or her own facial images and voice (or other video and audio). Optionally, the facilitator may also include supplemental information (e.g., computer data files). The audio, video, and optional supplemental material (collectively illustrated in FIG. 1 as facilitator data 165) is received at the server computer 110, e.g., via a direct connection or a computer network.

The server computer 110 executes program code 120 for receiving, merging, and formatting the user data 160 and facilitator data 165 into composite data 170 which may be delivered to the users via the service provider network 155. The two-way communication between the users and the facilitator continues (e.g., during class time), so that the virtual classroom simulates actual or “live”classroom activities.

Before continuing, it is noted that the composite data 170 may be formatted such that it can be readily and widely issued over a wide variety of conventional distribution channels (e.g., as a satellite and/or cable television signal). By way of illustration, a satellite signal may be transmitted to a satellite uplink facility for broadcast to the users, and decompressed by the satellite set-top box, as is conventional for satellite television signals. Accordingly, the users do not need to have computers/software or other specialized devices in order to receive and utilize the composite data 170.

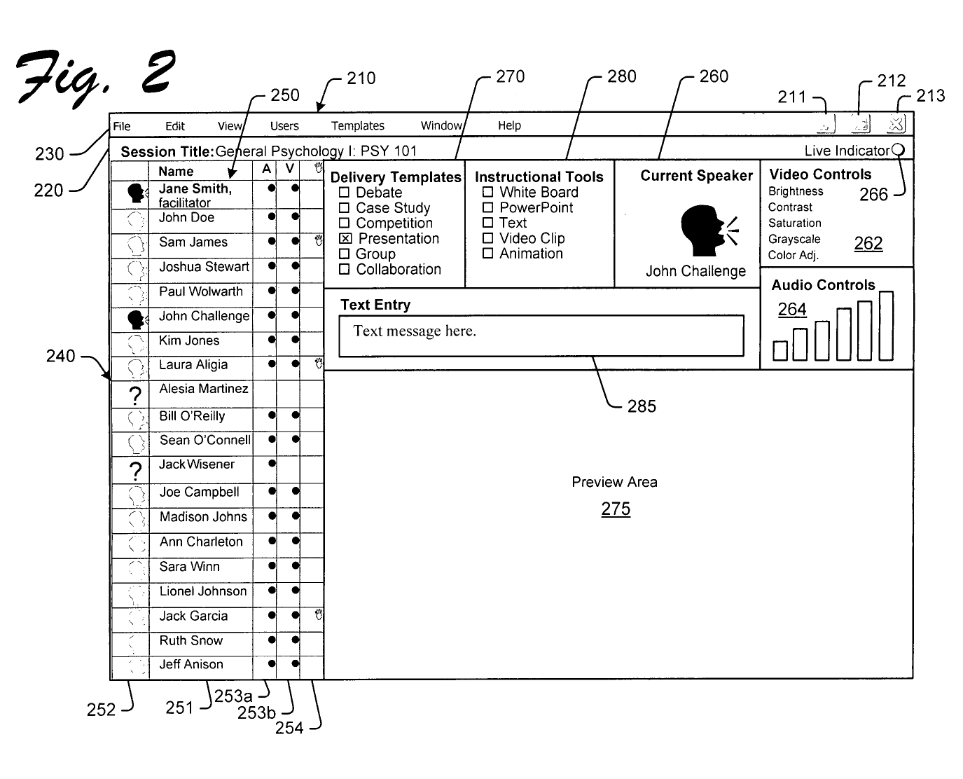

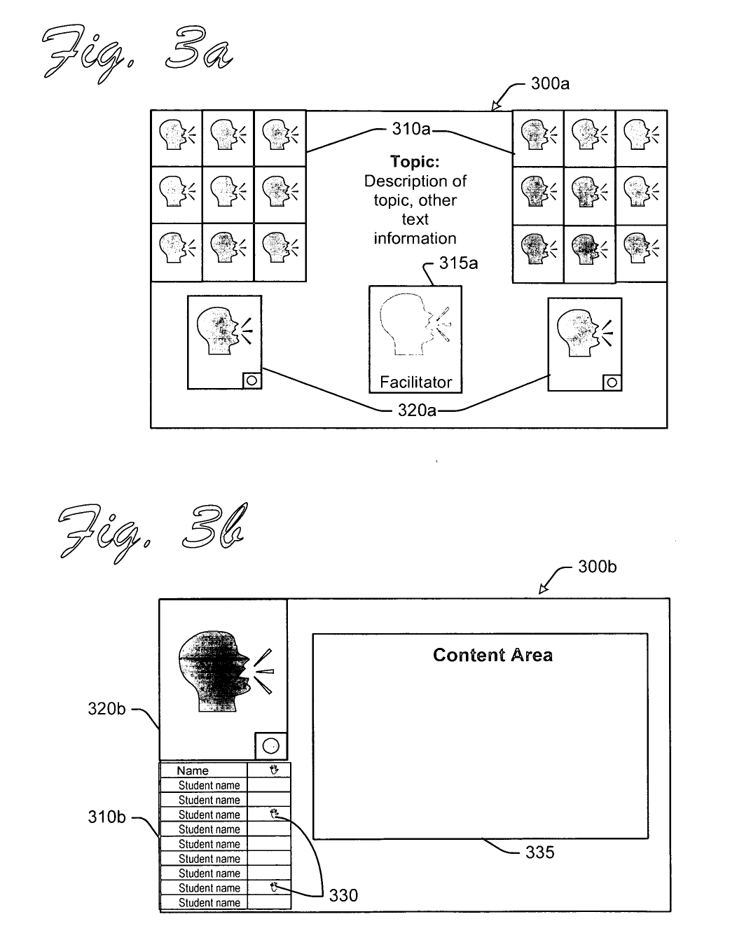

FIG. 2 is a screen shot showing an exemplary user interface 200 which may be implemented by a facilitator (e.g., on the facilitator computer 130 shown in FIG. 1) for synchronous communication for distance education. The user interface 200 may be operatively associated with program code for integrating a variety of input (e.g., different audio and video formats from different users) into a single output format (e.g., the composite data 170 shown in FIG. 1) for output to the users. The user interface 200 enables the facilitator to readily assemble and even customize the input for output to the users.

The graphical user interface (GUI) may be implemented in a “windows”operating system environment (e.g., Microsoft Corporation's WINDOWS®), although the user interface is not limited to use with any particular operating system. In an exemplary embodiment, the user interface 200 can be operated by the facilitator with little, if any, training. Functions, tools, and activities have clear, easy to understand usability indicators and may be operated with simple mouse clicks, click and drag procedures, and standard menu functions (e.g., File|Open, File|Save, etc.).

The facilitator may launch the user interface 200 in a customary manner, for example, by clicking on an icon, selecting the program from a menu, or pressing a key on a keyboard. The user interface 200 supports interaction with the facilitator through common techniques, such as a pointing device (e.g., mouse, style), keystroke operations, or touch screen. By way of illustration, the facilitator may make selections using a mouse to position a graphical pointer and click on a label or button displayed in the user interface 200. The facilitator may also make selections by entering a letter for a menu label while holding the ALT key (e.g., “ALT+letter” operation) on a keyboard. In addition, the user may use a keyboard to enter command strings (e.g., in a command window).

The user interface 200 is displayed for the facilitator in a window, referred to as the “application window” 210, as is customary in a window environment. The application window 210 may include customary window functions, such as a Minimize Window button 211, a Maximize Window button 212, and a Close Window button 213. A title bar 220 identifies the application window 210 (e.g., a title for the virtual classroom session). The application window 210 may also include a customary menu bar 230 having an assortment of pull down menus (e.g., labeled “File,” “Edit,” “View,” “Users,” “Templates,”“Window,” and “Help”). For example, the user may select a print function (not shown) from the “File” menu (designated herein as “File|Print”).

It is noted that the menu bar 230 may include any of a wide variety of different menus which are displayed when a pull down menu is selected. The menus may include standard menu options (e.g., File|Open, File|Save, File|Print, Edit|Copy, Edit|Cut, Edit|Paste, etc.). In addition, the menus may also include menu options which are specific to the application (e.g., Users|Register, Templates|Open) for managing the virtual classroom session.

Application window 210 also includes an operation space 240. Operation space 240 may include one or more graphics for displaying output and/or facilitating input from the user. Graphics may include, but are not limited to, subordinate windows, dialog boxes, icons, text boxes, buttons, and check boxes.

In an exemplary embodiment, operation space 240 displays a user list 250 with names 251 of registered users (e.g., students signed up for the virtual class). Presence icons 252 indicate to the facilitator whether a user is present. For example, the icons 252 may be shown in solid to indicate a user is present, and the icons 252 may be grayed out to indicate a user is registered but not connected to the virtual classroom session at this time. A/V icons 253a, 253b indicate whether the users are providing audio and/or video data which may be selected by the facilitator and output for the other users (such as when a user is actively participating in the discussion). Users may also “raise their hand,” (e.g., as shown by the hand indicator 254). User interaction such as this may be enabled, e.g., via an audio signal from the cell phone (DTMF tone), or through voice commands at the user's mobile device using voice recognition capabilities.

User interface 200 may also include other controls for the facilitator, such as, e.g., a current speaker indicator 260, video controls 262, and audio controls 264. Still other controls may also be provided for the facilitator, such as a live indicator 266 indicating whether the session is currently “live” (i.e., being broadcast or otherwise output to the users).

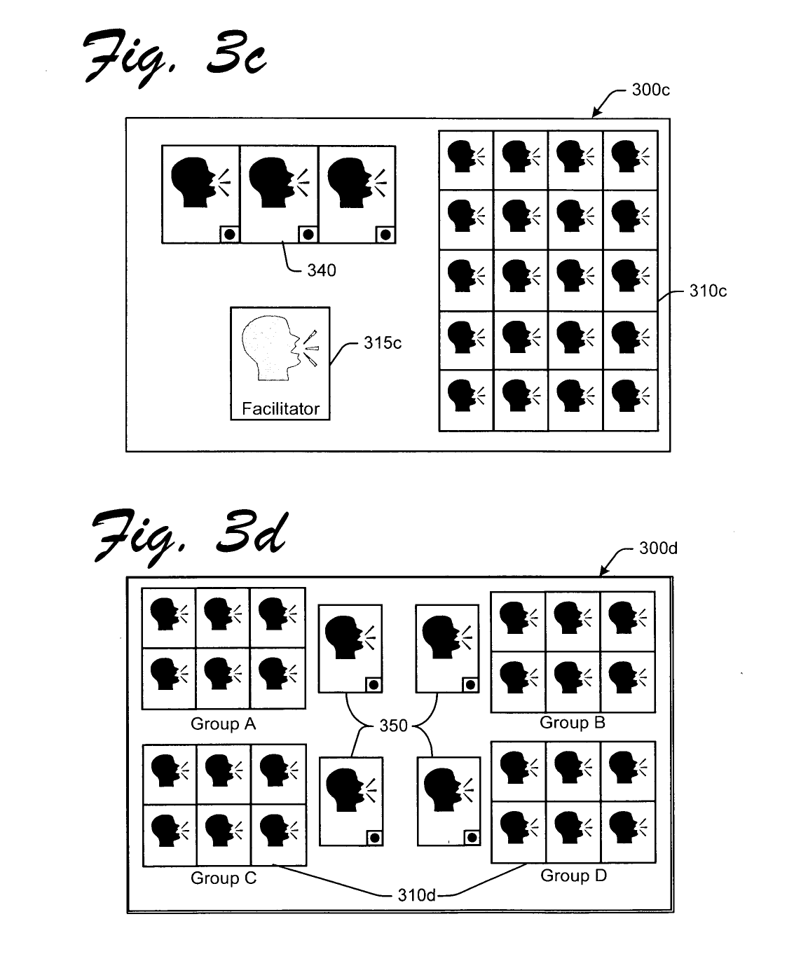

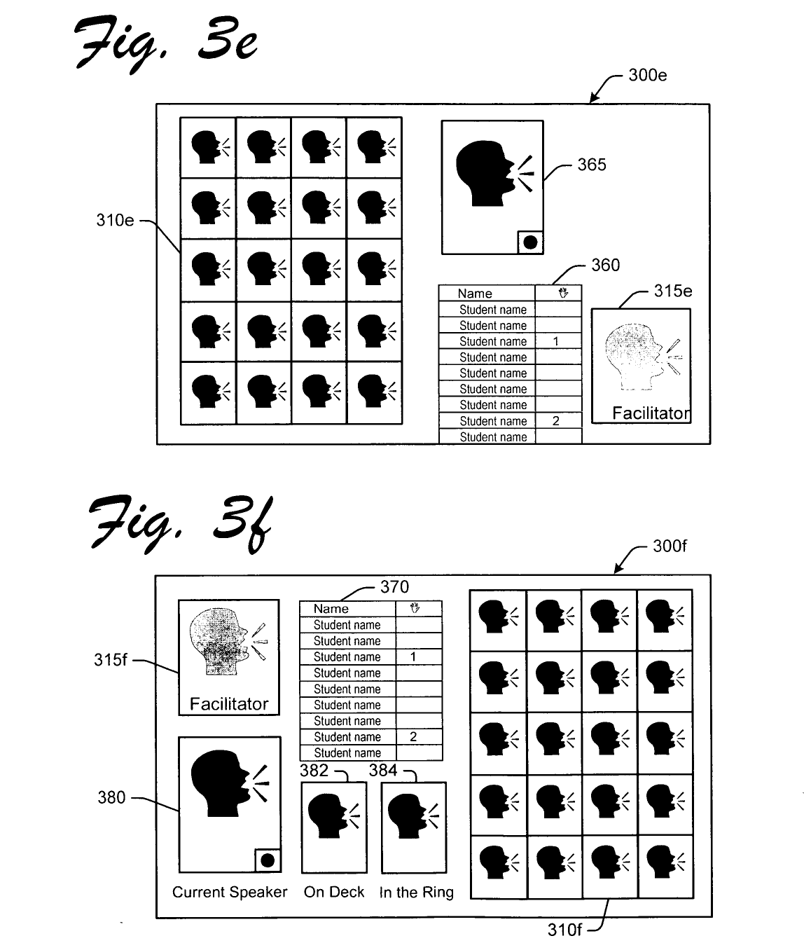

Exemplary user interface 200 also enables the facilitator to preview, sort, and format the input data (e.g., user data 160 and facilitator data 165) for output to the users in a “classroom-friendly” format (e.g., composite data 1 70) using a delivery template. The facilitator may select a delivery template, e.g., from the menu bar 230 by clicking on the “Templates” menu or via template selection box 270 by clicking next to the name or description of the desired delivery template. Exemplary delivery templates are illustrated in FIGS. 3a-f. For now it is enough to understand that the selection of a delivery template may depend on preferences of the facilitator, the type of output that is desired, among other factors. The selected delivery template may be displayed for the facilitator, e.g., in preview area 275 so that the facilitator sees the output being delivered to the users. The delivery template is then populated with various input data.

Input data may originate from several places. User data may reside on the server computer after being received from the users. The facilitator may drag and drop a user icon into the preview area to promote a user to active status (e.g., give the user speaking privileges). Several students may be in active status at the same time, e.g., in the case of a sample interview or group presentation.

The facilitator's audio and video may originate at the facilitator's computer, e.g., via a USB connected camcorder, webcam, or other recording device so that the facilitator may speak and have his or her image projected to students to enhance the virtual classroom experience.

Supplemental data may also be used for the instruction process. For example, the facilitator may operate the user interface 200 to access data files on the facilitator's hard disk drive, CD-ROM drive, DVD drive, Flash Drive, or any other storage media capable of storing computer-readable content. For example, the facilitator may desire to include a PowerPoint slide presentation (.ppt file format), a video clip from a DVD, or an audio file from a news report. The facilitator may open any document on his or her hard disk drive (or other storage device) and import it into the delivery template. The facilitator may also use different tools available via the user interface 200 to customize output via the delivery template and provide the desired virtual classroom experience for the users, e.g., using tools 280, by typing text directly for output to the users in text box 285, or dragging and dropping user icons into the preview area to grant specific users participation privileges. The facilitator may also deny user participation privileges (e.g., by clicking on a user and disabling audio and/or video from that user).

FIGS. 3a-f are screen shots showing exemplary delivery templates 300a-f which may be implemented for synchronous communication for distance education. Delivery templates 300a -f reflect instructional strategies commonly used in a traditional face-to-face classroom, and enable the facilitator to quickly and easily setup and switch between different instructional formats by selecting the desired delivery template. By way of illustration, delivery templates may be used to format output for the users for debate (FIG. 3a), presentations (FIG. 3b), case studies (FIG. 3c), group work (FIG. 3d), competitive work (FIG. 3e), and collaborative work (FIG. 3f). The delivery templates may be automatically populated with input data, and then issued as composite data for the users (e.g., as the composite data 170 shown in FIG. 1) so that the facilitator does not have to format the data and can focus his or her efforts on instruction. The populated delivery template may also be displayed for the facilitator (e.g., in preview area 275 shown in FIG. 2), e.g., so that the facilitator can see the same thing the users are seeing, and understand the effectiveness of the various delivery templates for different instructional scenarios.

In FIG. 3a, delivery template 300a may be used to format input data for a debate. For example, users 310a and the facilitator 315a may be displayed for the participants, thereby enhancing the virtual classroom experience. If one or more user is selected to speak (e.g., ask or answer a question), the selected user(s) 320a may be highlighted, e.g., by enlarging output for the selected user(s).

In FIG. 3b, delivery template 300b may be used to format input data for a presentation, e.g., lecture, student speech, or classroom demonstration. In this example, an active user 320b is shown enlarged, and the other users are identified in list 310b. Hand icons 330 may be displayed to indicate that one or more of the users wants to actively participate (e.g., by asking/answering a question). A content area 335 may display information, such as, e.g., a slide presentation, whiteboard illustrations, video clips, animation, etc.

In FIG. 3c, delivery template 300c may be used to format input data for case studies, such as, e.g., re-enacting interviews, court cases, and patient care. Users 310c and facilitators 315c are again displayed for participants. “Actors” 340 are shown separately as being active participants (e.g., the interviewer/interviewee).

In FIG. 3d, delivery template 300d may be used to format input data for group presentations. Users 310d are shown in groups (A-D), with active participants 350 from each group shown separately.

In FIG. 3e, delivery template 300e may be used to format input data for competition, such as, e.g., spelling bees, and question/answer sessions. Users 310e and facilitators 315e are shown, along with a list 360 of users indicating the order each user will be “called on” for participation. The currently active user 365 is shown separately. It is noted that the facilitator 315e is shown grayed out. When the currently active user 365 finishes, the facilitator 315e may become “live,” e.g., so that the facilitator 315e can announce the next participant from the list 360.

In FIG. 3f, delivery template 300f may be used to format input data for collaboration, such as, e.g., classroom discussions and brainstorming sessions. Users 310f and the facilitator 315f are shown, again with the facilitator 315f being grayed out. A list 370 of users is shown with numbers indicating the order each is expected to be “called on” for participation. In addition, the currently active user 380 is shown, along with icons 382 and 384 indicating the next two participants.

It is noted that the delivery templates 300a -f described with reference to FIGS. 3a-f are provided only as examples and are not intended to be limiting, either in format or in type. Other types and formats of delivery templates are also contemplated. In addition, in exemplary embodiments the facilitator may also customize the delivery templates, e.g., by clicking and moving icons to different areas of the delivery templates.

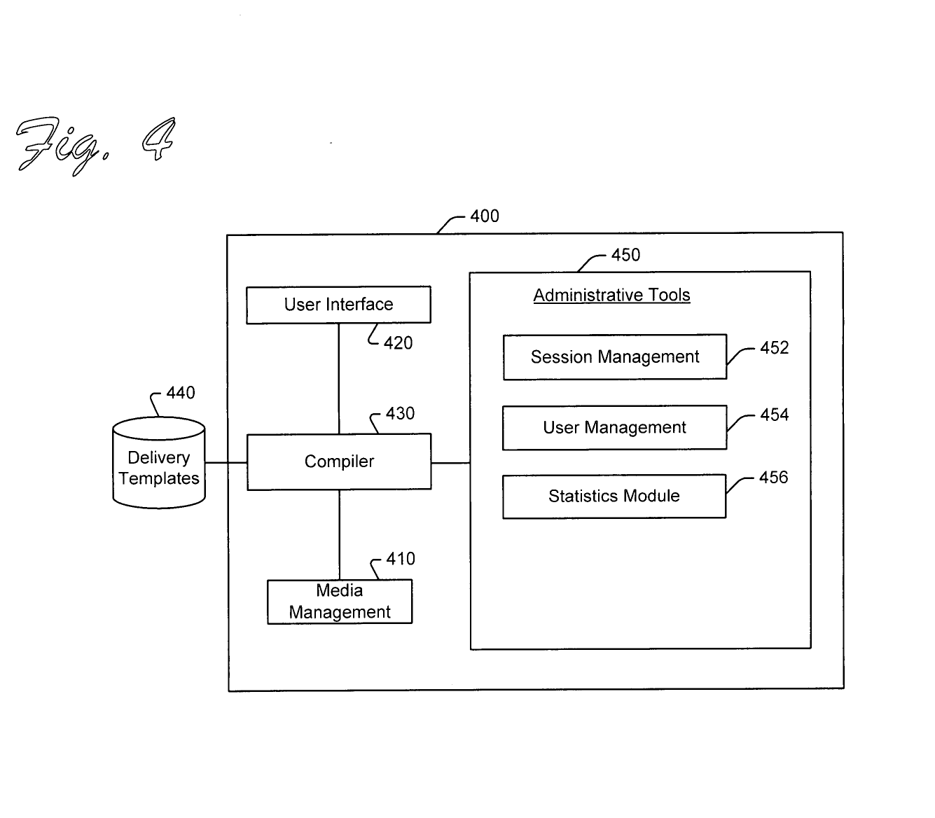

FIG. 4 is a high-level diagram illustrating exemplary functional modules which may be implemented for synchronous communication for distance education. The functional modules may be implemented as program code 400 (e.g., the program code 120 shown in FIG. 1) residing in memory and executable by a processor (e.g., on the server computer 110 in FIG. 1).

In an exemplary embodiment, the program code 400 may include a media management module 410. The management module 410 manages and stores input data (e.g., the user data 160 and facilitator data 165 illustrated in FIG. 1) for each session. The program code 400 may also include a user interface module 420 for interfacing with the facilitator (e.g., displaying the user interface 200 shown in FIG. 2).

A compiler 430 may be operatively associated with the management module 410 and the user interface module 420. Compiler 430 merges the user data and facilitator data based at least in part on input from the facilitator (via user interface module 420) to generate composite data (e.g., the composite data 170 illustrated in FIG. 1). In an exemplary embodiment, compiler 430 generates the composite data using a delivery template (e.g., the exemplary delivery templates illustrated in FIGS. 3a-f) from the delivery template database 440.

The program code may also include a number of administrative tools 450. Exemplary administrative tools 450 may include session management module 452 which enables the facilitator to open/close sessions, control session length, incoming data, outgoing streaming, etc. The session management module 452 also enables the facilitator to track and record virtual classroom sessions, and to connect and issue the composite data to service providers.

Other exemplary administrative tools 450 may include user management module 454. User management module 454 maintains a user database 455 with user information (e.g., name or other identification, type of connection, etc.). User management module 454 also maintains a user state table so that the facilitator can readily determine the state of each user (e.g., if a user is connected, sending user data, etc.). User management module also enables the facilitator to set user permissions for the session (e.g., if the user is allowed to actively participate) and/or terminate input from a particular user or group of users.

Still other exemplary administrative tools 452 may include statistics module 456 for tracking and reviewing statistics and creating reports. For example, statistics module 456 may track if and when each user connected, how long the user(s) were connected, and how actively each user participated. Reports may also be generated for the facilitator to use, e.g., when evaluating user attendance and performance.

Before continuing, it is noted that the functional components of program code 400 shown in FIG. 4 and described above are not intended to be limiting. The functional components shown in FIG. 4 do not need to be encapsulated as separate modules. In addition, other functional components (not shown) may also be provided and are not limited to those shown and described herein. For example, the program code may also handle security features for providing password protection, encryption, and/or other security. The program code may also handle network connectivity, and/or implement data compression algorithms for compression/decompression.

Exemplary Operations

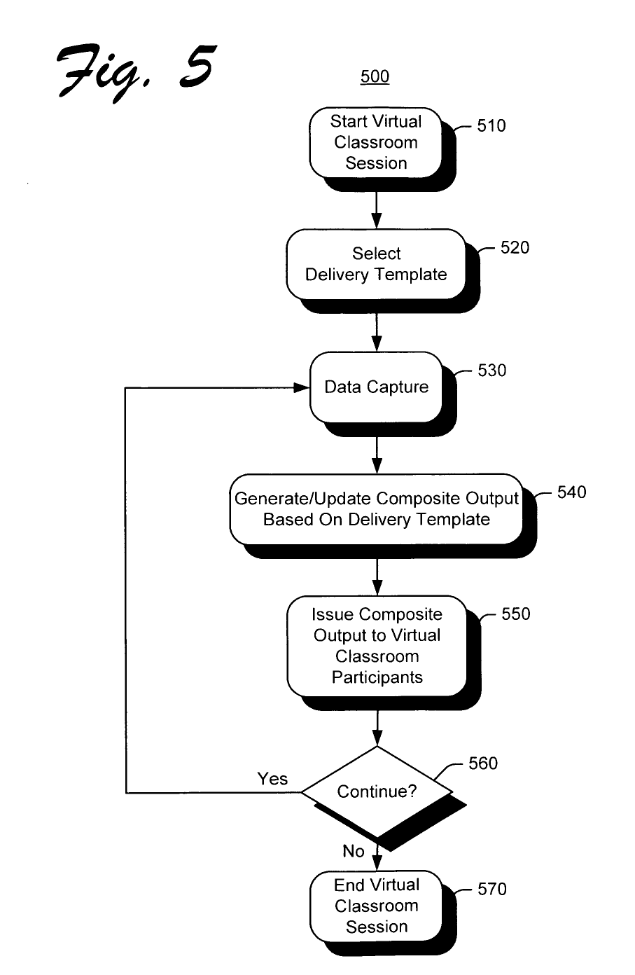

FIG. 5 is a flowchart illustrating exemplary operations which may be implemented for synchronous communication for distance education. Operations 500 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for synchronous communication for distance education.

In operation 510, a virtual classroom session may be started, e.g., by the facilitator. In operations 520, a delivery template may be selected. For example, the facilitator may select a delivery template from among a plurality of different types of delivery templates based at least in part on the type of virtual classroom session that is going to occur. In operation 530, data capture may occur. For example, data capture may include receiving user input from a plurality of users for the virtual classroom session, and receiving facilitator input from at least one facilitator for the virtual classroom session. In operation 540, composite output is generated (or updated) based on the format of the selected delivery template. For example, the composite output may be generated by merging the user input and facilitator input received in operation 530. The composite output may be issued to classroom participants in operation 550.

In operation 560, a determination is made whether to continue with the virtual classroom session. If the virtual classroom session is continuing, operations may return to continue data capture in operation 530. Otherwise the virtual classroom session may be ended in operation 570.

The operations shown and described herein are provided to illustrate exemplary implementations of synchronous communication for distance education. It is noted that the operations are not limited to the ordering shown. In addition, other operations may also be implemented. For example, operations may include registering users for the virtual classroom session and only allowing registered users to connect to the virtual classroom session, identifying all registered users for the virtual classroom session, and identifying which of the registered users are currently participating in the virtual classroom session. Still other operations may also be implemented, as will be readily apparent to those having ordinary skill in the art after becoming familiar with the teachings herein.

It is to be understood that the above embodiments and their variations are not mutually exclusive but can be combined in various ways to enable different aspects and features of synchronous communication systems and methods for distance education. Moreover, variations and modifications to the above-described exemplary embodiments will be apparent to one skilled in the art after becoming familiar with the teachings herein that are also within the spirit and scope of the claims.

1. A method of synchronous communication for distance education, comprising:
receiving user input from a plurality of users for a current virtual classroom session regardless of input format;
receiving facilitator input from at least one facilitator for the current virtual classroom session;
selecting a delivery template from among a plurality of delivery templates, the plurality of delivery templates corresponding to different types of virtual classroom sessions, and the selected delivery template corresponding to the type of the current virtual classroom session;
merging the user input and facilitator input into a composite output based on the selected delivery template; and
issuing the composite output to each of the plurality of users for the current virtual classroom session.

2. The method of claim 1 further comprising registering the plurality of users and only allowing registered users to connect to the current virtual classroom session.

3. The method of claim 2 further comprising identifying for the facilitator at least all registered users for the current virtual classroom session.

4. The method of claim 3 further comprising identifying for the facilitator which of the registered users are participating in the current virtual classroom session.

5. The method of claim 1 wherein the user input includes at least audio and video data, and the facilitator input includes at least audio, video, and supplemental information data.

6. The method of claim 1 wherein the delivery template is a user-interactive delivery template.

7. The method of claim 6 further comprising requesting at least one of the users to actively participate in the current virtual classroom session.

8. The method of claim 6 further comprising receiving a request from at least one of the users to actively participate in the current virtual classroom session.

9. The method of claim 1 further comprising at least partially customizing the selected delivery template based on facilitator preferences for the current virtual classroom session.

10. A computer program code product for synchronous communication for distance education, the program code product comprising:
a plurality of customizable delivery templates each corresponding to different types of virtual classroom settings; and
instructions executable by a computing device, the instructions merging user input and facilitator input, regardless of input format, to generate a composite audio/video output based on one of the customizable delivery templates for enhancing a virtual classroom experience.

11. The system of claim 10 wherein the delivery templates are interactive delivery templates for formatting as the composite audio/video output both facilitator contributions and user contributions to the virtual classroom experience.

12. The system of claim 10 wherein the delivery templates are preconfigured for at least the following virtual classroom experiences: debate, presentation, case study, group presentation, competition, and collaboration.

13. The system of claim 10 further comprising a user interface for the at least one facilitator, the user interface identifying at least all participants in the virtual classroom experience and a preview area showing the composite audio/video output.

14. The system of claim 13 wherein the user interface includes a plurality of instructional tools for the facilitator.

15. The system of claim 13 wherein the user interface includes a text entry box for entering text to display for the users.

16. The system of claim 10 further comprising instructions for promoting a user to active status, wherein at least audio data from the active status user is output to the other users.

17. The system of claim 10 further comprising instructions for recording the virtual classroom experience for asynchronous playback at a later time.

18. A system comprising:
means for receiving at least audio and video data from a plurality of users;
means for receiving at least audio, video, and supplemental instructional data from a facilitator; and
means for merging the data received from the plurality of users regardless of input format and the facilitator for output to all users based on a facilitator-selected delivery template to enhance a virtual classroom session.

19. The system of claim 18 further comprising:
means for registering the plurality of users for the virtual classroom session; and
means for only allowing registered users to connect to the virtual classroom session.

20. The system of claim 18 further comprising means for identifying all of the participants in the virtual classroom session.
